(19) United States
(12) Patent Application Publication
(10) Pub. No.: US 2009/0207687 A1
(43) Pub. Date: Aug. 20, 2009

(54) Apparatus and method for preparing ultrapure solvent blends

(75) Inventors: Anthony Kemperman, Whitehall, MI (US); Karel Snoble, Norton Shores, MI (US); Cynthia Seaver, Whitehall, MI (US); Matthew Bosma, Muskegon, MI (US); David North, Montague, MI (US); James Przybytek, West Olive, MI (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 11/988,767

(22) PCT Filed: Oct. 3, 2006
(86) PCT No.: PCT/US2006/038378

§ 371 Date: Jul. 11, 2008

Related U.S. Application Data
(63) Continuation of application No. 11/242,515, filed on Oct. 3, 2005.

(51) Int. Cl. G05D 11/02; B01F 5/04; B01F 15/04

(52) U.S. Cl. 366/132

(57) ABSTRACT

An apparatus and method for preparing solvent blends comprising: a manifold (45) having a first segment (18) and a second segment (46) in fluid communication with said first segment; a third segment (43) being in fluid communication with said first or second segments; a tubing section disposed within said first segment, said tubing section terminating downstream of said third segment; at least one solvent pump (12) in fluid communication with said manifold via said third segment; at least one additive pump (42) in fluid communication with said manifold via said tubing section; a static mixer (48) in fluid communication with said manifold via said second segment; and a control system (60) operatively associated with said pumps.

### BACKGROUND OF THE INVENTION

(1) Field of Invention

The present invention relates to an apparatus and methods for preparing ultrapure solvent blends.

(2) Description of Related Art

Ultrapure blends of liquid solvents are used in several industries for analytical and process applications. These blends may optionally include one or more additives, such as for example acids, bases, inorganic salts, and/or organic salts. For instance, in the pharmaceutical and environmental industries, solvent blends, often with small amounts of an acidic or alkaline additives, are used for analytical applications.

Examples of applications requiring ultrapure solvents include high performance liquid chromatography (hplc), ultraviolet (UV) spectrometry, mass spectrometry (MS), ion chromatography, and various other detection techniques such as fluorescence and Evaporative Light Scattering Detector (ELSD). Blends of solvents, optionally with small amount of additives, are also used for extraction of samples in preparation for gas chromatographic separation followed by detection using electron capture detection or MS detection and analysis. Published methods describing these techniques can be found in publicly available reference texts as P. C. Sadek, THE HPLC SOLVENT GUIDE, John Wiley & Sons, Inc, (New York) 1996; L. R. Snyder, et a., PRACTICAL HPLC METHOD DEVELOPMENT, 2^{ND} ED, John Wiley & Sons, Inc., (New York) 1997; L. R. Snyder and J. J. Kirkland, INTRODUCTION TO MODERN LIQUID CHROMATOGRAPHY, 2^{ND} ED., John Wiley & Sons, (New York) 1979; and, D. A. Skoog, PRINCIPLE OF INSTRUMENTAL ANALYSIS, 3^{RD} ED., Saunders College Publishing, (Philadelphia), 1971.

For certain analytical techniques, such as hplc analysis utilizing UV detection as the analyzer/identifier, the UV absorption characteristics of the solvent blends are critical for accurate analysis. That is, UV absorbing impurities in the process solvent may create an unacceptable increase in the background UV absorption that will interfere with the analysis. Moreover, if the equipment used to make such blends imparts impurities into the blended product, additional interfering impurity peaks may appear, complicating the analysis. Thus, ultrapure solvent blends are preferred for used with such techniques. Preparing such blends requires ultrapure solvents as starting materials, as well as an blending apparatus that will negligibly impact the final purity of the blend.

The quality and consistency of the solvent blends is also important in many of these same analytical processes. Variability in analytical results can occur if there is variability in the purity of the blends used for such analysis. Consistency between batches of solvent blends is particularly import where reproducibility of analytical results are critical; e.g., in Quality Assurance laboratories, where reproducibility of retention times of substances of interest is important for assuring the proper assay of the analyte. For example, the change in the concentration of a solvent modifier as trifluoroacetic acid can change the retention time of an analyte component of interest to outside the integration window, giving rise to an erroneous assay. Inconsistency in the solvent blend batches may also affect the peak shape, further resulting in erroneous assay results.

In the biotechnology art, the analysis of proteins or peptides is often made using hplc to separate particular samples, which are then analyzed by MS. Published examples of these applications are found in texts such as E. D. Katz, Ed., HIGH PERFORMANCE LIQUID CHROMATOGRAPHY: PRINCIPLES AND METHODS IN BIOTECHNOLOGY, (John Wiley & Sons, (New York) 1996. In the hplc/MS analysis of proteins or peptides, the purity of the solvent blends used in the analysis is critical because if the blends contain interfering impurities, or if the quality of the blends varies from lot to lot, the sensitivity of detection of the desired information is compromised. For example, if the impurities of a solvent blend vary from lot to lot, the background noise detected by a mass spectrometer may obscure, or at least increase the difficulty in detecting, low concentration fragment proteins, peptides, or amino acids.

In addition to analytical applications, ultrapure solvent blends, with or without additives, are used in the isolation or purification of certain substances in a laboratory or in a manufacturing plant. For example, a laboratory worker may use a solvent blend in a chromatographic method to isolate a compound or series of compounds from a mixture of compounds. In another example, a technician may use a solvent blend to purify a substance using column chromatography. In both laboratory and production environments, the production of solvent blends imposes safety concerns due to worker exposure to possibly hazardous materials. In the laboratory setting, workers often manually prepare the required blends of solvents and possibly solutes from separate components prior to use. These job duties potentially exposes the worker to hazardous chemicals common to the production of chromatographic solvent blends. For example, a blend of acetonitrile and trifluoroacetic acid is often used in hplc separations with UV detection of materials of interest. In this instance, a worker would potentially be exposed to, or risk spilling, two hazardous substances: acetonitrile which is toxic and flammable; and trifluoroacetic acid which is a highly corrosive and volatile acid. In the manufacturing setting, workers might be handling larger amounts of these substances, increasing the severity of a potentially hazardous spill or leak of material from a process vessel or package.

The amount of solvent blend for different application varies widely—for example laboratory testing vs. manufacturing. A means of producing such blends in the quantities desired would be advantageous from a quality, as well as an economic, perspective. For example, for applications requiring a relatively small amount of a solvent blend that has a short shelf life (e.g, acetonitrile/water/formic or trifluoroacetic acid), it would be desirable to produce small batches of such solvent blends so that the quality of the blend would not deteriorate prior to being consumed. Additionally, small batches of certain hazardous solvent blends would minimize the potential of a catastrophic event, such as a large fire or toxic spill.

Some applications require solvent blends having specifically tailored ratios of constituents, e.g., to get the desired separation of several components in a production environment, or to achieve the desired separation on an analytical instrument for unambiguous detection of the analyte of interest. To this end, a means of producing small batches of particular blends tailored to the specific need is desired.

Various methods and apparatuses have been disclosed for blending chemicals. U.S. Pat. No. 4,964,732 (Cadeo), for example, describes a method wherein separate chemicals are drawn from two or more storage tanks by solvent pumps and fed together into a static mixer. The flow of the individual components is measured by a flow meter which provides an input signal to a controller, which in turn, controls the speed of the pump. The method of Cadeo, however, is directed to blending bulk chemicals and therefore is generally inapplicable for producing the ultrapure blends required by analytical applications.

US 2004/0100860 (Wilmer) discloses a method and apparatus for blending ultrapure chemicals wherein individual chemicals are introduced into a recirculation vessel. The vessel is equipped with sensors for monitoring the composition of the blend and relaying relevant data to a control system which then adjusts the flow of a specific chemical into the vessel until the desired composition is achieved.

Yet another example is found in U.S. Pat. No. 6,923,568 (Wilmer) which discloses an apparatus wherein two or more ultrapure chemicals are blended together using a static mixer. According to the '568 patent, the flow of chemicals into the mixer is regulated by a controller, such as a programmable logic controller (PLC), that utilizes data from a sensor, such as a density sensor, to determine the necessary positions of control valves and/or the speeds of pumps. The '568 patent also discloses that when such an apparatus is used to blend corrosive chemicals, the wetted surfaces of the apparatus' piping, tubing, instruments, and pumps may be formed of fluoropolymers. (See also U.S. Pat. No. 6,271,188 (Eschwey) which discloses several polymer and metallic materials that are resistant to strong acids and bases.) These patents, however, fail to disclose any means of accurately reproducing solvents blends of the quality and reproducibility that are often required for analytical applications.

Thus, there remains a need in the art for method of economically and efficiently producing such ultrapure solvent blends. The present invention meets these and other needs in the art.

### SUMMARY OF THE INVENTION

The present invention provides an apparatus and method for reproducibly producing ultrapure solvent blends comprising one or more solvents and one or more additives, in the quantities and with the qualities desired, while minimizing the introduction of extraneous and potentially deleterious impurities into the blend. More particularly, applicants have invented an apparatus that is capable of consistently blending two liquid components of a solvent blend wherein the apparatus imparts virtually no impurities into the blend.

In one embodiment of the present invention, provided is an apparatus comprising a manifold having a first segment and a second segment in fluid communication with the first segment; a third segment being in fluid communication with the first or second segments; a tubing section disposed within the first segment, the tubing section terminating downstream of the third segment; at least one solvent pump in fluid communication with the manifold via the third segment; at least one additive pump in fluid communication with the manifold via the tubing section; a static mixer in fluid communication with the manifold via the second segment; and a control system operatively associated with said pumps. In preferred embodiments, all product contact surfaces of the apparatus are constructed of materials selected from the group consisting of 316 stainless steel, ceramic, sapphire, and perfluorinated polymers. Preferred embodiments also comprise a control system comprising a PLC and a flow meter for measuring the effluent flow from each solvent pump wherein the PLC controls the operation of the pumps to regulate the composition of the solvent blending being produced.

The solvent pump(s) and additive pump(s) produce effluent streams which are brought into contact by the manifold. For embodiments adapted to blend a plurality of solvents, the solvent pump effluents are brought together to produce a commingled solvent stream prior to contacting the additive pump effluent. The additive pump effluent is introduced into the solvent effluent stream or commingled solvent stream away from the stream's periphery and is also introduced into the stream prior to entering the static mixer. The additive effluent is thereby diluted before it contacts the surface material of the manifold segments, tubing connecting the manifold to the mixer, or the mixer itself. This is important since the additive may be acidic or caustic and thus have a corrosive effect on certain materials, such as 316 stainless steel, which may be used in the construction of the manifold, tubing connecting the manifold to the mixer, and the mixer itself.

Also provided is a method for producing ultrapure solvent blends having a predetermined ratio of components comprising (a) providing an apparatus according to present invention; (b) providing a measured stream of least one high purity solvent and a measured stream of at least one liquid additive; (c) combining the solvent stream with the additive stream to form a commingled solvent/additive stream; and (d) mixing the commingled solvent/additive stream to form a solvent blend; wherein the blend comprises the high purity solvents in a ratio that is within about ±1 percent of a predetermined ratio and further comprises a concentration of the additives within about ±10 percent of a predetermined amount. In certain preferred embodiments, a plurality of measured streams of high purity solvents are provided and are combined to form a commingled solvent steam prior to contact with the additive stream.

### BRIEF DESCRIPTION OF THE DRAWINGS

FIG. 1 is a diagram of an embodiment of the apparatus of the present invention having two solvent pumps and one additive pump;

FIG. 2 is a diagram of another embodiment of the apparatus of the present invention having four solvent pumps and two additive pumps; and

FIG. 3 is a detailed diagram of the additive junction.

### DETAILED DESCRIPTION OF THE INVENTION

The present invention is directed to an apparatus and method for blending at least two components of an ultrapure solvent blend wherein said blend comprises one or more solvents and, optionally, one or more additives. The robustness and adaptability of the apparatus makes it suitable for preparing a wide variety of solvent blends. To facilitate the understanding of the present invention, the following description is generally directed to an embodiment having two or more solvent pumps and a four-way manifold (i.e. a manifold having four segments.) However, the invention is not limited to such embodiments and specifically includes, for example, an apparatus having one solvent pump, one additive pump, and a three-way Tee-manifold, embodiments having more than two solvent pumps and a manifold having more than four segments, and the like.

As used herein, the term “solvent” means a substance capable of dissolving another substance (i.e. the solute) to form a uniformly dispersed mixture (i.e. solution) at the molecular- or ionic-size level. “Solvent” therefore broadly encompasses a wide variety of substances including, but not limited to, water, organic compounds, aqueous solutions, including polar and dipolar (high dielectric constant) compounds, non-polar (low dielectric constant) compounds, aprotic compounds, and nonaprotic compounds. Examples of such solvents include, but are not limited to, water, aromatic hydrocarbons, aliphatic hydrocarbons, halogenated hydrocarbons, halocarbons, alcohols, esters, ethers, ketones, amines, nitrates, aqueous ionic solutions, and the like. Specific examples of solvents suitable for the present invention, include but are not limited to, acetonitrile, methanol, isopropanol, and water.

The term “blend”, as used herein, means a uniform combination of two or more substances either of which could be used alone for a purpose that is the same as or similar to that of the blend. For example, blends of the present invention can include mixtures of acetonitrile/trifluoroacetic acid (99.9:0.1); acetonitrile/trifluoroacetic acid (99.95:0.05), acetonitrile/formic acid (99.9:0.1); acetonitrile/acetic acid (99.9:0.1); acetonitrile/water (50:50); water/trifluoroacetic acid (99.9:0.1); water/formic acid (99.9:0.1); and methanol/water (50:50); acetonitrile/water/trifluoroacetic acid (89.95:9.95:0.1); acetonitrile/water/trifluoroacetic acid (9.95:89.95:0.1); methanol/water/formic acid (94.95:4.95:0.1); methanol/water/formic acid (4.95:94.95:0.1); and water/acetonitrile/acetic acid/trifluoroacetic acid (97.89:2.0:0.1:0.01).

While the blending apparatus of the present invention is suitable for use in preparing a solvent blend for any application, it is particularly suitable for the blending of ultrapure solvents where accuracy and precision are desired. The present invention is particularly useful for preparing blends for use in the pharmaceutical, cosmetic, and microelectronic industries, as well as for use in chemical assays, and the like.

The type and level of acceptable impurities in solvent blends varies depending upon the application for which the solvent is being used. For example, applications involving UV spectrometry, it is desirable to have no detectable UW (190 nm to 400 nm) absorbing compounds. The detection limit is determined by the instrument, and would vary from instrument to instrument and from manufacturer to manufacturer. It is also dependent upon the extinction coefficient of the absorbing impurity. For a typical UV spectrometer, a detection limit for a typical aromatic impurity, benzene, is for example 1 ppm using a 1 cm path length UV cell. A widely available American Chemical Society (ACS) text which describes the UV performance requirements for a UV suitable acetonitrile (Liquid Chromatography Suitability for Specific Use Grade Acetonitrile) to detect impurities at 0.005 AU (absorbance units). See REAGENT CHEMICALS, 9 TH EDITION, American Chemical Society, New York, 2000, which is incorporated herein by reference. An ultrapure acetonitrile would have no impurities larger than 0.001 AU using this method.

The apparatus of the present invention is capable of blending ultrapure solvents meeting these and other criteria for purity. That is, using acetonitrile as a standard, the apparatus is capable of processing streams of ultrapure acetonitrile through its solvent pumps, additive pumps, manifold, and mixer, to produce an ultrapure acetonitrile product having no impurities larger than 0.00 1 AU using the above-mentioned ACS method.

Using ultrapure water as a standard, the apparatus is capable of processing streams of ultrapure water through its solvent pumps, additive pumps, manifold, and mixer, to produce an ultrapure water product having less than 0.5 ppm of any residual solvent as provided for in 2005 US Pharmacopoeia Method 467, which is incorporated herein by reference.

The apparatus is also capable of producing ultrapure solvent blends having a non-volatile solid residue of less than about 1 ppm by weight.

According to one aspect of the present invention, an apparatus is provided that includes a manifold having a first segment and a second segment in fluid communication with the first segment; a third segment being in fluid communication with the first or second segments; a tubing section disposed within the first segment, the tubing section terminating downstream of the third segment; at least one solvent pump in fluid communication with the manifold via the third segment; at least one additive pump in fluid communication with the manifold via the tubing section; a static mixer in fluid communication with the manifold via the second segment; and a control system operatively associated with said pumps. Preferred embodiments also comprise a flow meter to measure the effluent flow from each solvent pump and a control system that, in part, communicates with the flow meters and controls the pumps to regulate the composition of the solvent blending being produced.

Each solvent pumps is used to transfer a solvent or a combination of solvents from a supply source to the mixer. The supply source may be any form of container or vessel from which an ultrapure solvent or ultrapure combination of two or more solvents may be extracted. In certain embodiments, the apparatus has at least two pumps so that at least two different solvents are delivered to the mixer for blending, although such an embodiment may also be used to blend a single solvent with one or more additives. In certain embodiments, the apparatus may be equipped with more than two pumps so that additional solvents may be incorporated into the blend. In general, one pump is needed for each solvent or solvent combination that is simultaneously introduced into the mixer.

Solvent pumps according to the present invention are preferably positive displacement pumps, for example piston pumps, diaphragm pumps, peristaltic pumps, and are preferably electrically operated. The solvent pump's capacity and accuracy is preferably sized to facilitate the production of an ultrapure solvent blend. For embodiments adapted to produce relatively low volumes of ultrapure solvents blends for hplc (high performance liquid chromatography), gas chromatography, UV spectrometry, mass spectrometry, ion chromatography, and pharmaceutical or chemical assays or processes, the solvent pump is preferably a piston-type pump having a capacity of from about 1.0 to about 10 gallons per minute, more preferably from about 1.0 to about 5 gallons per minute, and even more preferably from about 0.25 to about 2.0 gallons per minute. The above-mentioned pump capacities may be achieved by using the same model pump, but adjusting the pump's bore and stroke and/or modifying the gear ratio of the pump. Preferably, the solvent pumps have a cumulative flow accuracy of within about ±1.0%, more preferably within about ±0.5%, and even more preferably within about ±0.1% By “cumulative accuracy” it is meant the sum of the accuracies of the individual pumps. For example, if four solvent pumps are used and each pump has an individual accuracy of ±0.25%, then the cumulative accuracy for all four pumps is ±1.0%.

It is also preferable that all product contact surfaces (i.e. wetted surfaces) of the apparatus be constructed of materials that will not impart contaminants into the solvent or detract from the solvent's efficacy. These product contact surfaces include the pump's body, shaft and piston assemblies, cylinder walls, seals, gaskets, check valves, at the like. In preferred embodiments, the materials of construction will be 316 stainless steel, ceramic, sapphire, perfluorinated polymers (e.g. TEFLON®, TEFLON® PFA, KALREZ®, and ISOLAST®), or some combination thereof.

Solvent pumps adaptable for use with the present invention may be purchased commercially, but will likely require modification before being suitable for producing ultrapure solvent blends. Examples of such solvent pumps are 311 Triplex Plunger Pump commercially available from CAT Pumps of Minneapolis, Minn., ProMinent Extronic Additive pump 1002 commercially available from Fluid Metering, Inc. (FMI) of Syosset, N.Y., and LMI Series B Electronic Additive pumps commercially available from Liquid Metronics Incorporated (LMI) of Acton, Mass. These pumps, as well as most other commercially available pumps, include at least some product contact surfaces that are not constructed of 316 stainless steel or perfluorinated polymer. To produce ultrapure solvent blends having the exceptionally low contaminant levels of the present invention, these pumps must be modified so that all gasket and seal material is a perfluorinated polymer, and any check valves, relief values, etc., are constructed of 316 stainless steel or perfluorinated polymer.

The additive pump is used to transfer a liquid additive from a supply source to the mixer. Additives for use with the present invention include, but are not limited to, organic or inorganic bases, organic or inorganic acids, and dissolved organic or inorganic salts. Specific examples of suitable additives include, but are not limited to, trifluoroacetic acid, formic acid, phosphoric acid, acetic acid, triethyl amine, trisodium phosphate, and other phosphate salts.

The apparatus may be equipped with more than one additive pumps so that two or more additives may be incorporated into the blend. In general, one pump is needed for each additive that is simultaneously introduced into the mixer. Preferably, the additive pumps for use with the present invention are metering pumps which are characterized as being highly precise in controlling fluid flow. Such metering pumps include reciprocating piston additive pumps, piston pumps, diaphragm pumps, peristaltic pumps, and the like. Preferably, these pumps are electrically controlled and operated.

The additive pump's capacity and accuracy is preferably sized to facilitate the production of an ultrapure solvent blend having relatively small amounts of additives for example from about 0.5 ml to about 10 ml of additive per liter of solvent blend. Typically, the capacity of the additive pump is related to the capacity of the solvent pumps (i.e. larger additive pumps are generally used with larger solvent pumps). Preferably, the capacity ratio of the solvent pump to the metering pump is from about 15,000:1 to about 100:1, more preferably from about 2,000:1 to about 100:1, and even more preferably from about 2000:1 to about 200:1. For example, for embodiments utilizing solvent pumps that each have a capacity of 1.9 gallons per minute, the preferred capacity of a metering pump may be from about 0.5 to about 72 ml/min, more preferably from about 3.6 to about 72 mil/min, and even more preferably from about 3.6 to about 36 ml/min.

For embodiments adapted to produce relatively low volumes of ultrapure solvent blends with additives for hplc, gas chromatography, UV and MS spectrometry, ion chromatography, and pharmaceutical or chemical assays or processes, the additive pump preferably has a capacity of from about 0.5 to about 72 ml/min, more preferably from about 3.6 to about 72 ml/min. and even more preferably from about 3.6 to about 36 ml/min. Preferably, each additive pump will have an individual flow accuracy of about ±2%. Cumulatively, the accuracy of the additive pumps will be about ±10%. Such additive pumps are particularly desirable when the solvent pumps have an output of about 1.9 gallons per minute. For these embodiments, the additive pumps preferably have a cumulative flow accuracy of within about ±10% and more preferably within about ±2%.

Since the additives flowing through the pump can be highly acidic or caustic, the product contact surface of the additive pump are preferably constructed of a material that is highly resistant to corrosion (e.g. the electrochemical degradation of a material via oxidation or some other reaction). Preferably, all product contact surfaces of the additive pump will be perfluorinated polymer, and ceramic.

An apparatus according to the present invention also preferably comprises a tubing system that brings the solvent pumps, metered pump, and static mixer into fluid communication. As using herein, the term “tubing system” means one or more interconnected hollow, cylindrical conduits that are capable of conveying a fluid. Such tubing may include; in whole or in part, drawn tubing, hot or cold rolled tubing, annealed tubing, piping, flexible hoses, and the like.

In certain embodiments, the tubing system comprises a plurality of tubing sections. For tubing sections that are designed to transfer non-corrosive or mildly corrosive fluids (e.g. solvents), the tubing is preferably constructed of 316 stainless steel. In certain preferred embodiments, the tubing is also electro-polished in order to reduce the tube surface's susceptibility to corrosion. However, this section of tubing is preferably not passivated. For tubing sections that are designed to transfer corrosive fluids (e.g. additives such as strong acids and strong bases), the tubing is preferably constructed of perfluorinated materials. Individual tube pieces have flanged ends and are connected with clamping devices, such as tri-clamps, and gasket materials. The product contact surfaces of the gasket material is preferably constructed of perfluorinated materials.

In certain preferred embodiments, the tubing system comprises two or more sections of tubing for individually transferring each solvent from its source to its respective solvent pump, one or more sections of tubing for individually transferring each additive from its source to its respective additive pump, a section of tubing for transferring the effluent of each pump to the commingling junction, a section of tubing for transferring the commingled solvents and additive(s) to the mixer, and a section of tubing for transferring the effluent of the mixer to a downstream point for further processing. The tubing system may also comprise one or more of the following: size and/or fitting adapters, bulkhead fittings, caps, compression fittings, coupling or connector or hose menders, flexible couplings, 4-way crosses, crimp sockets, 90 degree elbows, 45 degree elbows, other angle elbows, reducing elbows, expansion joint couplings, ferrules, glands, nipples, offsets, plugs, concentric reducers, eccentric reducers, return or traps, check valves, side outlet elbows, side outlet tees, equal tees, reducing tees, bullhead tees, crow feet tees, sanitary tees, unions, reducing wyes, swivel connectors, and the like. For embodiments that include more than two solvent pumps or that include more than one additive pumps, the tubing system may further include one or more tee or wye fittings to bring the join two or more solvent streams or two or more additive streams prior to their introduction into the commingling junction.

For embodiments adapted to produce relatively low volumes of ultrapure solvents blends for hplc, gas chromatography, UV and MS spectrometry, ion chromatography, and pharmaceutical or chemical assays or processes, the tubing preferably is a standard tubing from about ¼-inch to about 1-inch in diameter. More preferably, the tubing sections for transferring the solvent pump effluents are constructed of ¾-inch diameter stainless steel tubing, the tubing section(s) for transferring the additive pump(s) effluent(s) are constructed of ¼-inch diameter perfluorinated polymer tubing, and the tubing section for transferring the commingled solvents and additive(s) to the mixer is constructed of ¾-inch diameter stainless steel tubing that is at least about 2 inches in length, and is more preferably about 6 inches in length.

The manifold for bringing the effluent streams of the solvent pumps and the effluent stream(s) of the additive pump(s) into contact is preferably a four-way manifold. Preferably, this manifold is constructed of 316 stainless steel and includes four segments, each of which are approximately cylindrical in shape, are approximately orthogonal to their respective adjacent segments, have a flanged end, and have a diameter that is approximately three to four times the diameter of the tubing section used to transfer the effluent of the additive pump(s). Two of the manifold segments are adapted to mate with the section of the tubing system for transferring the effluent of the solvent pumps. Preferably, these two segments are on opposite sides of the manifold. Another segment of the manifold is adapted to mate with the section of tubing for transferring the commingled solvent/additive stream to the mixer.

Another segment of the manifold is adapted to receive the tubing section for transferring the effluent of the additive pump(s). The tubing enters into this segment, traverses the entire length of the segment, and then enters the interior of the segment for transferring the solvent/additive stream to the mixer before terminating. In certain preferred embodiments, this tubing extends at least about ¼ of an inch into this latter segment and terminates in an annular opening. The disposition of this tubing section inside of the four-way cross manifold directs the additive flow into the middle of the commingled solvent stream. By introducing the additive at this location, the additive is advantageously diluted by the commingled solvent stream prior to coming into contact with the tubing walls of the tubing section for transferring the commingled solvent/additive steam to the mixer. Since the additive may be acidic or caustic, and therefore corrosive, it is preferable to limit direct contact of undiluted additives with the components of the apparatus that are constructed of stainless steel.

In certain preferred embodiments, the four-way cross manifold is disposed so that the segment receiving the tubing from the additive pump is vertical and on top of the manifold. This orientation facilitates the flow of the additive stream through the manifold via gravity assistance.

The static mixer is used to complete the final blending of the solvents and optional additives. Static mixers suitable for use with the present invention have a mixing region that is shaped to cause agitation and mixing of the process materials as they flow through the region, and are preferably in-line static mixers or passive micromixers. In-line static mixers may be constructed with one or more baffles or other flow disruption elements in order to subject the process materials to turbulent flow conditions as they pass through the mixer. For example, the mixer may comprise one or more helical flow disruption elements, a toroidally shaped baffle, wafer disruption element, blade disruption element, flanges, and/or a conically shaped disruption element. Each type of flow disruption element can be designed to create different types of turbulence—such as eddy formations, vortices, and the like, and to accommodate solvents and additives materials with different viscosities. Such mixers may have a single stage or multiple stages to achieve optimal mixing.

In preferred embodiments, the mixer receives the commingled solvent/additive process stream from a single inlet. The product contact surfaces of the mixer are constructed of 316 stainless steel, Hastelloy®, Teflon®, and/or other perfluorinated polymers. For embodiments adapted to produce relatively low volumes of ultrapure solvents blends for hplc (high performance liquid chromatography), gas chromatography, UV spectrometry, mass spectrometry, ion chromatography, and pharmaceutical or chemical assays or processes, the mixer is preferably constructed of 316 stainless steel and includes from about one to about twelve internal mixing elements. The exact number of mixing elements is dependent upon the overall mixer design. Examples of commercially available mixers for use with the present invention include model ISG Eight Element In-line Mixer from Charles Ross and Son of Hauppauge, N.Y., model series 275, 330, or 400 from Koflo Corp. of Cary, Ill., model stainless steel or teflon static mixer from EMI Inc. Technology Group (Cleveland Eastern Mixers Division) of Clinton, Conn., or model Slit Plate Mixer LH1000 from Erhfeld Mikrotechnik BTS of Wendelsheim, Germany.

In certain preferred embodiments, the effluent from the static mixer can be directed to a holding vessel or final packaging system. For embodiments utilizing a holding vessel, the solvent blend is stored until needed. Storing the solvent blend in a storage vessel may allow the blended product to be tested for acceptability prior to being transferred to a point of use.

In certain preferred embodiments, the apparatus may be equipped with an equilibration purge system. Such a purge system is useful during initial start-up, or at any other time that a blended product may not be acceptable, because it provides a means for the blend to be diverted away from the holding vessel and into a disposal system. Preferably, such a purge system comprises an automated three-way valve disposed down stream of the mixer and upstream of the holding vessel or other point of use. The three-way valve can selectively divert the flow of blended product away from a holding vessel and into a drain. Such as system is particularly useful during the initial start-up of the system when the operation of the blending system may not have reached equilibrium. Generally, this initial start-up period is from about 1 to about 60 seconds.

In preferred embodiments, the apparatus of the blending system includes a control system for monitoring and controlling the pumps, valves, and mixer of the system. The control system reduces errors in the production of blends by minimizing the number of instances that an operator must adjust the mechanical parts of the apparatus. In addition, the consistency and quality of the product is increased by limiting the operations and measurements that an operator must perform. Moreover, such a control system increases the safety aspects of operating the apparatus because it will minimize the number of opportunities that an operator might come into contact with hazardous substances.

The control system may include a controller capable of receiving information and acting upon information based upon a series of protocols, such as logic code. For example, the controller may be a microprocessor based device such as a computer or PLC. Preferably, the controller is electrically connected to one or more input devices, such as sensors, from which it receives information related to the operation of the blending system. The controller, in turn, is electrically connected to the pumps and, optionally, electrically controlled, pneumatically actuated values, and regulates the operation of these devices based upon the information it receives from the input devices and from preprogrammed instructions. The control system may also include various non-automated sensors, such as pressure gauges.

In certain highly preferred embodiments, the control system includes a mass flow meter for each solvent pump and, optionally, for each additive pump. The flow meters are disposed so that they can effectively measure the effluent flow from their respective pump. The mass flow meter sends an electronic signal to the controller indicating the actual effluent flow from the pump. Based upon the information received from the flow meters and the preprogrammed instructions, the controller can adjust the speed of the pump in order to create the desired ratio of components in the final blended product.

Additionally, in certain highly preferred embodiments, the control system automatically controls the three-way valve of the equilibrium purge system. For example, the blending system can be configured so that the blended product is sent to drain for the first 30 seconds after start-up to allow for the system to reach equilibrium before directing the blended product to a holding vessel.

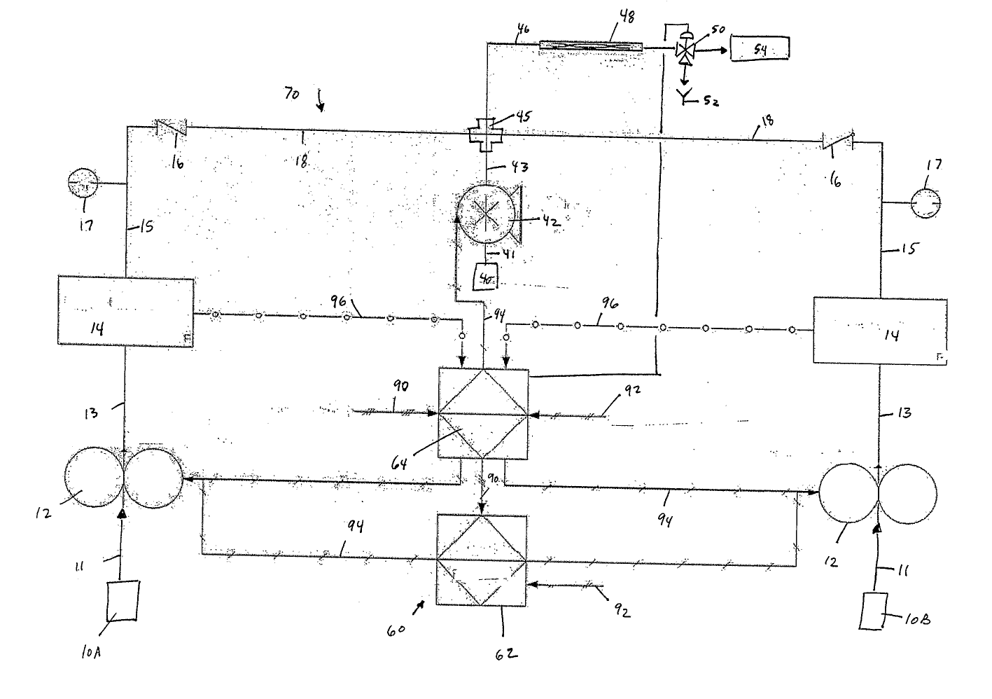

Referring now to FIG. 1, an illustrative embodiment of the apparatus of the invention is shown. As shown in FIG. 1, a first solvent supply source 10A and a second solvent supply source 10B are fluidly connected to separate solvent pumps 12 via sections 11 of a tubing system 70. These tubing sections 11 are preferably constructed of ½-inch diameter PFA tubing. Pumps 12 are preferably piston-type pumps, each having a pumping capacity of from about 0.25 to about 1.0 gallons per minute and an accuracy of ±0.1%. Preferably the total capacity of the solvent pumps 12 is limited to 2 gallons per minute so as not to over-pressurize the apparatus. Although the pumps shown in this embodiment have the same capacity, there is no requirement that other embodiments of this invention comprise solvent pumps having the same capacity. Each of these pumps draws its respective solvents from the solvent supply source and preferably transfers it in through another ¾-inch diameter 316 stainless steel section 15 of the tubing system 70, past pressure gauge 17 and check valve 16, through the another ¾-inch diameter 316 stainless steel section 18 of the tubing system 70 and to the four-way cross manifold 45.

An additive supply source 40 is fluidly connected to an additive pump 42 via a section 41 of the tubing system 70. This section 41 of the tubing system is preferably constructed of ¼-inch diameter perfluorinated material. This additive pump 42 is preferably a diaphragm-type metering pump having a pumping capacity from about 3.6 ml/min to about 36 ml/min and an accuracy of ±2%. More preferably, the pump 42 is a ProMinent Extronic Metering Pump Model 1002. This pump 42 draws the additive from the supply source 40 and transfers it through section 43 of the tubing system, which is preferably constructed of ¼-inch diameter perfluorinated material, and into the four-way cross manifold 45.

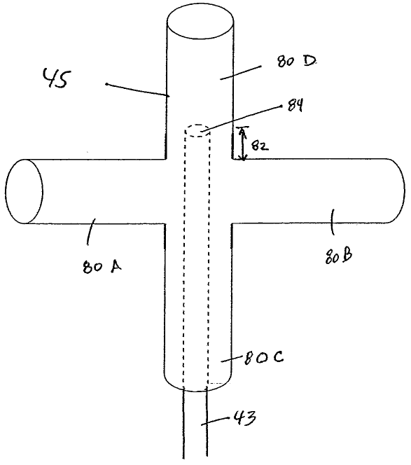

The four-way cross manifold 45, further shown in FIG. 3, is preferably constructed of 316 stainless steel and preferably has four, ¾-inch diameter cylindrically-shaped segments 80A-D, wherein each segment is orthogonal to the segments which are adjacent to it. Segments 80A and 80B are adapted to receive tubing sections 18 which is a conduit for the solvent effluents from the solvent pumps 12. Segment 80C is adapted to receive tubing section 43 which is a conduit for the additive effluent from the additive pump 42. The tubing section 43 traverses the inside of segment 80C and extends into segment 80D by the distance 82 where it terminates. The distance 82 in this embodiment is preferably about ¼ inch. The terminal segment 84 of tubing section 43 is preferably a simple cylindrical opening. Terminal segment 80D is adapted to receive a ¾-inch diameter 316 stainless steel section of tubing 46 for transferring the commingled solvent and additive to the static mixer 48. (See FIG. 1.)

The mixer 48 is preferably an eight-element static mixer. This mixer performs the final blending of the solvents and additive to produce the final blended product.

A control system 60 is shown having a PLC controller 64 and an electrical drive system 62, both of which are preferably enclosed in separate explosion proof cabinets which are equipped with a source of nitrogen gas 92 for blanketing the interior of the cabinet. The control system receives raw electrical power 90 which is directed to the drive system 62. The drive system modifies the raw electrical power based upon instructions from the PLC controller 64 and sends the modified electrical power 94 to the solvent pumps 12. Modified electrical power 94 is also sent to the additive pump 42. The controller receives a data signal 96 from mass flow meters 14 and regulates the operation of the solvent pumps accordingly.

The PLC controller 64 also controls the actuation of the automated three-way valve 50. This valve is electrically controlled and pneumatically actuated. The controller is programmed to direct the flow of blended solvent from the mixer 48 to drain 52 for the first few seconds after start-up, after which the controller signals the three-way value 50 to send the blended solvent to a holding vessel 54 for subsequent processing.

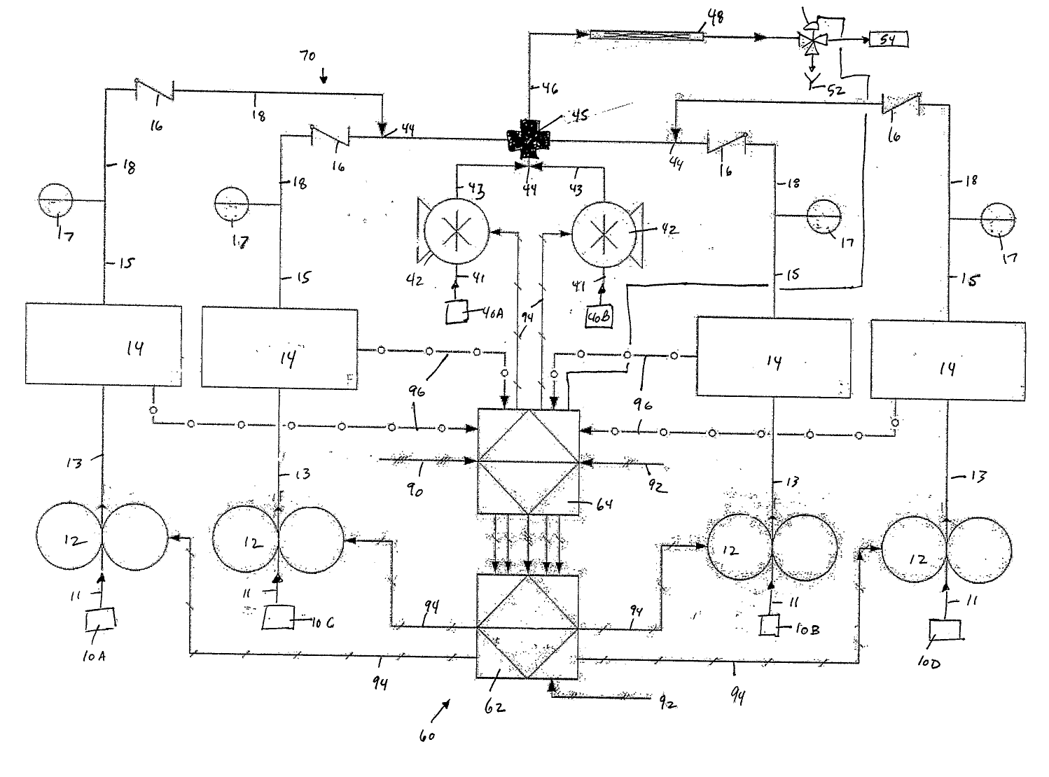

Another embodiment of the present invention is shown in FIG. 2. In this embodiment, the apparatus is equipped with four solvent pumps 12 for transferring four separate solvents from their respective sources 10A-D. This apparatus is also equipped with two additive pumps 42 for transferring two separate additives from their respective sources 40A-B. The solvent effluents derived from 10A and 10C and from 10B and 10D are combined via tee or wye prior to entering the four-way cross manifold 45. Likewise the additive effluents derived from 40A and 40B are combined via tee or wye prior to entering the four-way cross manifold 45.

According to another aspect of the invention, provided are methods of using the above-mentioned blending system to prepare ultrapure solvent blends. In one preferred embodiment, the method comprises (a) providing the above-mentioned apparatus; (b) providing two or more high purity solvents; (c) combining a measured steam of a first solvent with a measured stream of a second solvent to form a commingled solvent stream; (d) introducing a measured amount of an additive into the commingled solvent stream to form a commingled solvent/additive stream; and (e) mixing the commingled solvent/additive stream to form a solvent blend; wherein said blend is comprises the first and second solvents in a ratio that is within about ±1 percent of a predetermined ratio and further comprises a concentration of the additive within about ±10 percent of a predetermined amount.

The blends produced by this method extract from the apparatus less than about 1 ppm by weight of a volatile organic compound and less than about 1 ppm of a non-volatile residual compound. Specific examples of such volatile organic compounds and non-volatile residual compounds include conjugated carbonyl compounds, conjugated aromatic compounds, ionic iron moieties, ionic nickel moieties, and polymeric compounds. In addition, the blend is characterized in that the efficacy of the additive or solvent is not diminished or compromised contact with or exposure to the apparatus.

According to certain preferred embodiments of the method, the method produces from about 20 liters to about 2000 liters of solvent blend, more preferably from about 20 liters to about 200 liters of solvent blend, and even more preferably from about 20 to about 50 liters of solvent blend.

Also, according to certain preferred embodiments of the method, the ultrapure solvent blend is produced at a rate of from about 0.5 to about 10 gallons per minute, more preferably from about from about 1 to about 5 gallons per minute, and even more preferably from about 0.25 to about 2 gallons per minute.

### EXAMPLES

### Examples 1-8

The embodiment of the invention depicted in FIG. 1 was used to produce the solvent blends identified in Examples 1-8. These blends were analyzed to determine each blend's purity. This analysis included testing for non-volatile residuals, UV absorbing impurities, color intensity, potentiometric titration, and hplc peaks. The procedure used for these tests are similar to those described in REAGENT CHEMICALS, 9 TH EDITION, American Chemical Society, New York, 2000, particularly pages 15-16 (Non-volatile Residue), 18-19 (American Public Health Association (APHA) Color Intensity). 51-52 (Potentiometric Titration), 70-71 (hplc), and 73 (UV impurities), which are incorporated herein by reference.

The results of these tests are presented in Table 1:

With respect to the residue testing, the test is designed to determine the amount of any higher boiling impurities or non-volatile dissolved material that may be present in a liquid chemical. The results in Table 1 demonstrate that less than 1 ppm of dissolved solids were present in the products produced using the described invention. This is important in that non-volatile residue causing impurities can cause higher noise levels, column damage, and ‘ghost’ peaks.

With respect to the UV testing, the test is designed to determine the level of absorbance from 400 nm to 190 nm caused by any absorbing impurities that may be present in a liquid chemical. The results in Table 1 demonstrate that there are no spectral impurities equal to or greater that the reference absorbance (blank) or set specifications at each wavelength. This finding is important in that UV absorbing impurities in the process solvent may create an unacceptable increase in the background UV absorption that will interfere with the analysis a user of the blend may be performing.

With respect to the color intensity testing, the test is designed to determine the color intensity of liquids compared to Platinum/Cobalt standards. The results in Table 1 demonstrate that materials produced by the described invention have a color of less than 10 APHA units compared to the standards. These results demonstrate that products produced from this invention have no detectable color absorbing impurities. This is of importance because color producing substances in products produced with would be an indicator of the presence of impurities.

With respect to the potentiometric titration testing, the test is designed to determine the equivalence point by the measuring of the potential difference of two points in this case an acid and a base. The results in Table 1 demonstrate that materials produced by the described invention are within 10% of the required amount of acid. This test is used to verify the performance of the additive pump by keeping the additive level within the tolerance specified. These results also show the repeatability of the acid pump to meet the tolerance result from product batch to product batch. The importance of this result is that it shows the acid content to be relatively constant, resulting in reduced variation in retention times, improved peak shape and consistent peak shape during hplc chromatography.

With respect to the hplc testing, the test procedure was similar to that given at pages 70-71 of REAGENT CHEMICALS, 9 TH EDITION, American Chemical Society, New York, 2000, but with the following modifications:
the column used for testing was a Phenomenex Gemini C-18 hplc column, 3 micron particles, 150 mm by 2.1 mm column dimensions;
the detector used for testing was an ultraviolet at 254 nm, coupled with TIC MS detector; and
the gradient program used had the following parameters:

| Time (min) | Flow (ml/min) | Solvent A (%) | Solvent C (%) |
|---|---|---|---|
| 0 | 0.15 | 10 | 90 |
| 20 | 0.15 | 90 | 10 |
| 25 | 0.15 | 90 | 10 |
| 30 | 0.15 | 10 | 90 |

Solvent A is water with either 0.1% trifluoroacetic acid or 0.1% formic acid and Solvent B is acetonitrile with either 0.1% trifluoroacetic acid or 0.1% formic acid.

This test is designed to determine the level of hplc performance of a solvent blend. The results from Table 1 (Pass) show that no peaks had an absorption of greater than 0.005 AU via the test method. Results as these are critical for accurate hplc analysis. Background UV absorption is at an acceptable level. Interfering impurity peaks are minimal (below 0.005 AU). The results also indicate that variability of the hplc performance of the products produced by this invention has been reduced.

TABLE 1

| Exam- | | Potentio- | | | | |
|---|---|---|---|---|---|---|
| ple | | metric | APHA | Resi- | | |
| No. | Blend | Titrat. Acid | (color) | due | HPLC | UV |
| 1 | water/formic | 0.101% | <10 | <1 | Pass | Pass |
| | acid | | | | | |
| 2 | acetonitrile/ | 0.103% | <10 | <1 | Pass | Pass |
| | formic acid | | | | | |
| 3 | acetonitrile/ | 0.102% | <10 | <1 | Pass | Pass |
| | trifluoroacetic | | | | | |
| | acid | | | | | |
| 4 | water/ | 0.100% | <10 | <1 | Pass | Pass |
| | trifluoroacetic | | | | | |
| | acid | | | | | |
| 5 | water/formic | 0.102% | <10 | <1 | Pass | Pass |
| | acid | | | | | |
| 6 | acetonitrile/ | 0.106% | <10 | <1 | Pass | Pass |
| | formic acid | | | | | |
| 7 | acetonitrile/ | 0.093% | <10 | <1 | Pass | Pass |
| | trifluoroacetic | | | | | |
| | acid | | | | | |
| 8 | water/ | 0.100% | <10 | <1 | Pass | Pass |
| | trifluoroacetic | | | | | |
| | acid | | | | | |

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. An apparatus for preparing solvent blends comprising:
(a) a manifold having a first segment and a second segment in fluid communication with said first segment;
(b) a third segment being in fluid communication with said first or second segments;
(c) a tubing section disposed within said first segment, said tubing section terminating downstream of said third segment;
(d) at least one solvent pump in fluid communication with said manifold via said third segment;
(e) at least one additive pump in fluid communication with said manifold via said tubing section;
(f) a static mixer in fluid-communication-with said manifold-via-said second segment; and
(g) a control system operatively associated with said pumps.

2. The apparatus of claim 1 wherein said first and second segments are disposed along an axis.

3. The apparatus of claim 2 wherein a plurality of segments are laterally connected to said manifold along said axis and are in fluid communication with said first or second segment.

4. The apparatus of claim 3 wherein said plurality of segments is about two segments.

5. The apparatus of claim 4 wherein said manifold is a four-way cross manifold.

6. The apparatus of claim 1 wherein all product contact surfaces of said apparatus are constructed of materials selected from the group consisting of 316 stainless steel, ceramic, sapphire, and perfluorinated polymers.

7. The apparatus of claim 1 having from about 2 to about 4 solvent pumps.

8. The apparatus of claim 1 wherein said solvent pumps independently have a pumping capacity of from about 0.25 to about 10 gallons per minute.

9. The apparatus of claim 8 wherein said solvent pumps independently have a pumping capacity of from about 0.25 to about 5 gallons per minute.

10. The apparatus of claim 9 wherein said solvent pumps independently have a pumping capacity of from about 0.25 to about 2 gallons per minute.

11. The apparatus of claim 1 wherein said solvent pumps have a cumulative accuracy of about ±1.0 percent.

12. The apparatus of claim 1 wherein said solvent pumps have a cumulative accuracy of about ±0.5 percent.

13. The apparatus of claim 1 wherein said solvent pumps have a cumulative accuracy of about ±0.1 percent.

14. The apparatus of claim 1 wherein said solvent pumps and said additive pumps have a cumulative capacity ratio of from about 15,000:1 to about 100:1.

15. The apparatus of claim 14 wherein said capacity ratio is from about 2,000:1 to about 100:1.

16. The apparatus of claim 15 wherein said capacity ratio is from about 2000:1 to about 200:1.

17. The apparatus of claim 14 wherein said additive pump has a capacity of from about 0.5 to about 72 ml/min.

18. The apparatus of claim 17 wherein said additive pump has a capacity of from about 3.6 to about 72 ml/min.

19. The apparatus of claim 18 wherein said additive pump has a capacity of from about 3.6 to about 36 ml/min.

20. The apparatus of claim 1 further comprising a equilibrium purge system comprising an automated three-way valve fluidly connected to said mixer.

21. A method for preparing a solvent blend having a predetermined ratio of components comprising:
(a) providing an apparatus according to claim 1;
(b) providing a measured stream of least one high purity solvent and a measured stream of at least one liquid additive;
(c) combining said solvent stream with said additive stream to form a commingled solvent/additive stream; and
(d) mixing said commingled solvent/additive stream to form a solvent blend; wherein said blend comprises said high purity solvents in a ratio that is within about ±1 percent of a predetermined ratio and further comprises a concentration of said additives within about ±10 percent of a predetermined amount.

22. The method of claim 21 wherein a plurality of measured streams of high purity solvents are provided and further comprising combining said plurality of solvent streams to form a commingled solvent steam prior to (c).

23. The method of claim 22 wherein said plurality of solvent streams comprise from about two to about four solvents steams and said at least one liquid additive stream comprises from about one to about four additive streams.

24. The method of claim 21 wherein said solvents are independently selected from a group consisting of water, organic solvent, and aqueous solutions, provided that each of the solvents are different compounds.

25. The method of claim 24 wherein said solvents are independently selected from a group consisting of water, aromatic hydrocarbons, aliphatic hydrocarbons, halogenated hydrocarbons, halocarbons, alcohols, esters, ethers, ketones, amines, nitrates, and aqueous ionic solutions.

26. The method of claim 24 wherein said organic solvents are selected from the group consisting of acetonitrile, methanol, isopropanol, hexane, acetone, n-methylpyrrolidone, dimethyformamide, dimethylsulfoxide, dichloromethane, and ethanol.

27. The method of claim 21 wherein said additives are independently selected from the group consisting of strong acids, strong bases, and organic and inorganic salts.

28. The method of claim 27 wherein said additive is selected from the group consisting of trifluoroacetic acid, formic acid, phosphoric acid, acetic acid, sodium hydroxide, triethylamine, piperdine, pyridine, ammonium acetate, sodium chloride, sodium monophosphate, sodium diphosphate, and sodium triphosphate.

29. The method of claim 21 wherein said solvent blend comprises less than 1 ppm by weight of an impurity derived from said apparatus, wherein said impurity is selected from the group consisting of volatile organic compounds and non-volatile residual compounds.

30. The method of claim 21 wherein apparatus does not affect the efficacy of said additives or said solvents in said solvent blend.

31. The method of claim 29 wherein said impurities are selected from the group consisting of conjugated carbonyl compounds, conjugated aromatic compounds, ionic iron moieties, ionic nickel moieties, and polymeric compounds.

32. The method of claim 21 wherein said solvent blend comprises said high purity solvents in a ratio that is within about ±0.2 percent of a predetermined ratio and further comprises a concentration of said additives within about ±10 percent of a predetermined amount.

33. The method of claim 21 wherein said solvent blend is produced in batches from about 20 liters to about 2000 liters.

34. The method of claim 33 wherein said solvent blend is produced in batches from about 20 liters to about 200 liters.

35. The method of claim 34 wherein said solvent blend is produced in batches from about 20 liters to about 50 liters.

36. The method of claim 21 wherein said blend is produced continuously at a rate of from about 1 gallons per hour to about 10 gallons per hour.

37. The method of claim 36 wherein said blend is produced continuously at a rate of from about 1 gallons per hour to about 4 gallons per hour.

38. The method of claim 37 wherein said blend is produced continuously at a rate of from about 1 gallons per hour to about 2 gallons per hour.
